(19) United States
(12) Patent Application Publication
(10) Pub. No.: US 2026/0039169 A1
(43) Pub. Date: Feb. 5, 2026

(54) SYSTEM AND METHOD FOR DELIVERING ELECTRIC POWER

(71) Applicant: GC Universal, INC., Tokyo (JP)

(72) Inventor: Young Been Kim, Colleyville, TX (US)

(73) Assignee: GC Universal, INC., Tokyo (JP)

(21) Appl. No.: 18/789,001

(22) Filed: Jul. 30, 2024

(51) Int. Cl. H02K 7/00; H02K 1/27; H02K 5/04; H02K 7/08; H02K 9/22

(52) U.S. Cl. CPC H02K 7/003; H02K 1/27; H02K 5/04; H02K 7/08; H02K 9/22

(57) ABSTRACT

A system for transferring electric power is provided. A power supply conductor conducts a power supply current that generates a first resultant magnetic field. An electric motor has a power input terminal connected to the power supply conductor and a movable output component. A generator has a movable input component connected to the movable output component such that the movable output component causes movement of the movable input component. The generator converts the movement of the movable input component into a power output current to the power output terminal that generates a second resultant magnetic field.

### BACKGROUND OF THE INVENTION

### 1). Field of the Invention

This invention relates to a system and method for transferring electric power.

### 2). Discussion of Related Art

A multitude of devices these days use rechargeable batteries, for example lithium-based rechargeable batteries. Mobile phones, vehicles, drones and the like are normally disconnected from an electric power supply grid when they are being operated, which causes their batteries to lose their charge. The batteries then have to be connected to an electric power supply grid so that they can be recharged.

It usually takes at least a half an hour, and often more time to fully recharge a fully-depleted battery. Batteries generate a fair amount of heat when they are being recharged and an excessive amount of heat can cause damage to a battery, which can destroy the battery or reduce its life expectancy. Battery chargers are designed to limit the rate at which power is provided to the batteries when they are being recharged so that their temperatures remain below the temperature at which damage may occur.

A battery charger normally includes a single phase alternating current power supply conductor with a socket that is connected to a wall outlet. The wall outlet is connected to an electric power supply grid. The battery charger includes a rectifier that converts alternating current received from the electric power supply grid to direct current. The direct current is then provided through a delivery circuit to positive and negative terminals on a battery. A power controller may be included to control the amount of power that is provided to the battery, although it may be possible to control power provided to the battery by connecting multiple batteries in series or in parallel.

When designing a battery charger, various factors are normally taken into account. For example, the voltage and power supplied by the electric power supply grid, the inclusion of transformers and the number and sizes of the batteries are taken into consideration, especially for purposes of minimizing the temperatures of the batteries while they are being charged. However, no satisfactory explanation has been forthcoming as to why the batteries heat up in the first place. For example, Ohm's law, which states that the sum of voltages in a closed loop will always equal zero, does not provide a satisfactory explanation as to why the batteries heat up during recharge.

Heat generation results in a high temperature that limits how fast a battery can be charged. A high temperature also limits the voltage to which a battery can be charged, which means that the capacity of the battery is decreased with a corresponding decrease in time before the battery runs out of charge. High charging temperatures means that the lifetime of the battery, i.e. the number of times that the battery can be recharged, is reduced as described in “BU-806a: How Heat and Loading affects Battery Life.” A high temperature also results in a danger of explosion as described in “Why phones explode sometimes, and what you can do to protect yourself” by Robert Triggs. It is also not possible to recharge batteries that are considered not rechargeable. For example, lithium-based batteries are rechargeable, but alkaline-based batteries are not rechargeable. A net negative effect on the environment is created when alkaline-based batteries are dispensed as described in “What Do Batteries Do to the Environment If Not Properly Recycled?” by Kathy Kattenburg.

Outside of the field of battery chargers, other electric power delivery systems often suffer the same fate of excess heat that cannot be readily explained. For example, it is not always possible to explain why certain electric fires happen when the systems are subsequently analyzed for failures using engineering principles that are commonly available at this time.

### SUMMARY OF THE INVENTION

The invention provides a system for transferring electric power including a power supply conductor to conduct a power supply current that generates a power supply magnetic field, an electric motor having a power input terminal connected to the power supply conductor and a movable output component, the electric motor being configured to convert the power supply current to movement of the movable output component; and a generator having a movable input component connected to the movable output component such that the movable output component causes movement of the movable input component, and a power output terminal, the generator being configured to convert the movement of the movable input component into a power output current to the power output terminal that generates a generator magnetic field that is uncoupled from the power supply magnetic field.

The system may further include a housing, a shaft movably mounted to the housing, wherein the movable output component and the movable input component are parts of the shaft, wherein the motor includes a motor stator mounted to the housing and a motor rotor mounted to the shaft, and wherein the generator includes a generator stator mounted to the housing and a generator rotor mounted to the shaft.

The system may further include a push fan, and a pull fan, the push fan and the pull fan being mounted in positions so that air flows sequentially over the push fan, then over a unit that includes the electric motor and the generator, and then over the pull fan.

The system may further include a resistor load, a controller, and a switching circuit that is connected to the controller, the controller being operable to switch the switching circuit between a charging configuration wherein the power output terminal is connectable to a battery to charge the battery and the battery is disconnected from the resistor load, and a discharging configuration wherein the output terminal is disconnected from the battery and the battery is connected to the resistor load to discharge the battery.

The invention also provides a method of transferring electric power including conducting a power supply current that generates a power supply magnetic field, converting the power supply current to movement of the movable output component, and converting the movement into a second electric current that generates a generator magnetic field that is uncoupled from the power supply magnetic field.

The method may further include that the movable output component and the movable input component are parts of a shaft, wherein the motor includes a motor stator mounted to the housing and a motor rotor mounted to the shaft, and wherein the generator includes a generator stator mounted to the housing and a generator rotor mounted to the shaft.

The method may further include that air is directed over a push fan and a pull fan so that air flows sequentially over the push fan, then over a unit that includes the electric motor and the generator, and then over the pull fan.

The method may further include switching, with a controller, a switching circuit between a charging configuration wherein the output terminal is connectable to a battery to charge the battery and the battery is disconnected from a resistor load, and a discharging configuration wherein the output terminal is disconnected from the battery and the battery is connected to the resistor load to discharge the battery.

The invention further provides a system for transferring electric power including means for conducting a power supply current that generates a power supply magnetic field, means for converting the power supply current to movement of the movable output component, and means for converting the movement into a second electric current that generates a generator magnetic field that is uncoupled from the power supply magnetic field.

The system of claim may further include that the movable output component and the movable input component are parts of a shaft, wherein the motor includes a motor stator mounted to the housing and a motor rotor mounted to the shaft, and wherein the generator includes a generator stator mounted to the housing and a generator rotor mounted to the shaft.

The system may further include that air is directed over a push fan and a pull fan so that air flows sequentially over the push fan, then over a unit that includes the electric motor and the generator, and then over the pull fan.

The system may further include means for switching a switching circuit between a charging configuration wherein the output terminal is connectable to a battery to charge the battery and the battery is disconnected from a resistor load, and a discharging configuration wherein the output terminal is disconnected from the battery and the battery is connected to the resistor load to discharge the battery.

### BRIEF DESCRIPTION OF THE DRAWINGS

The invention is further described by way of example with reference to the accompanying drawings;

FIG. 1 is a partially cross-sectioned side view of a system for transferring electric power, according to an embodiment of the invention; and

FIG. 2 is a block diagram of the system illustrating further components thereof.

### DETAILED DESCRIPTION OF THE INVENTION

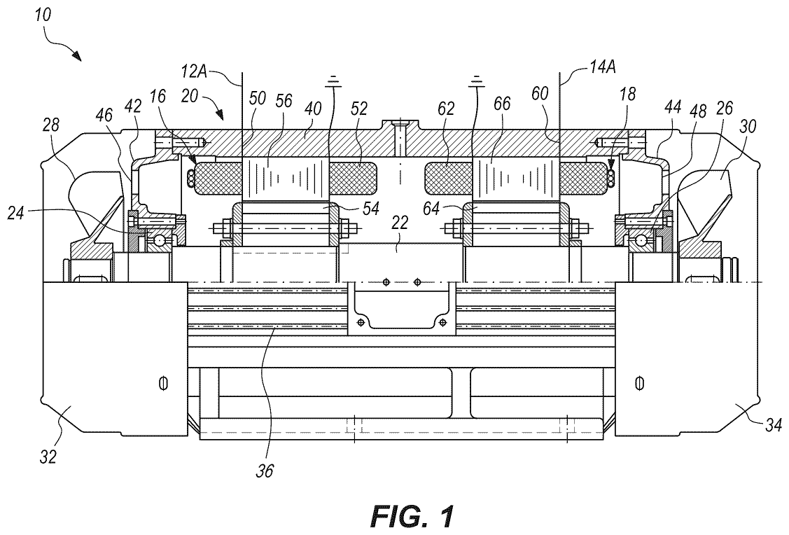

FIG. 1 of the accompanying drawings illustrates a system 10 for transferring electric power, according to an embodiment of the invention, including a power supply conductor 12A, a power delivery conductor 14A, an electric motor 16, a generator 18, a housing 20, a shaft 22, first and second shaft bearings 24 and 26, a push fan 28, a pull fan 30, an air inlet piece 32, an air outlet piece 34, and cooling fins 36.

The housing 20 includes cylindrical main body 40 and first and second endcaps 42 and 44. The endcaps 42 and 44 are located over opposing ends of the main body 40. The shaft 22 is located through openings in the endcaps 42 and 44. The shaft bearings 24 and 26 mount the shaft 22 to the endcaps 42 and 44, respectively, while allowing for rotation of the shaft 22 relative to the housing 20.

The push fan 28 and the pull fan 30 are mounted to opposing ends of the shaft 22 outside the housing 20. The endcaps 42 and 44 have openings 46 and 48, respectively, through which air can enter and exit the housing 20. The openings 46 are aligned blades of the push fan 28 so that the push fan 28 can propel the air through the openings 46. The openings 48 are aligned with blades of the pull fan 30 so that air moving through the housing 20 and exiting through the openings 48 can be further discharged by the pull fan 30.

The air inlet piece 32 and the outlet air piece 34 are mounted to the endcaps 42 and 44 of the housing 20. The air inlet piece 32 is located around the push fan 28 and is open to the left. The air outlet piece 34 is located around the pull fan 30 and is open to the right.

The electric motor 16 includes a power input terminal 50, a motor stator 52, a motor rotor 54, and motor magnetic field line guides 56.

The motor stator 52 includes a plurality of electromagnetic coils (only one shown) that are mounted in a stationary position to the housing 20. The electromagnetic coil is connected to the power input terminal 50. The power input terminal 50 is connected to the power supply conductor 12A. In one example, six electromagnetic coils of the motor stator 52 may be mounted at different locations to the housing 20 and two of the electromagnetic coils are connected to the power supply conductor 12A with two other electromagnetic coils connected to another power supply conductor (not shown), and the last two electromagnetic coils connected to a further power supply conductor (not shown). In such an arrangement, three-phase power can be provided to the six electromagnetic coils of the motor stator 52.

The motor rotor 54 includes a plurality of permanent magnets. The permanent magnets are mounted at various locations around a circumference of the shaft 22. The permanent magnets of the motor rotor 54 are located within electromagnetic fields generated by the various electromagnetic coils of the motor stator 52.

The motor magnetic field line guides 56 are mounted to the housing 20. The motor magnetic field line guides 56 are separate ferromagnetic pieces with gaps between them. A pitch from one of the motor magnetic field line guides 56 to the next is selected to be between one and two millimeters.

The generator 18 includes a power output terminal 60, a generator stator 62, a generator rotor 64, and generator magnetic field line guides 66.

The generator stator 62 includes a plurality of electromagnetic coils (only one shown) that are mounted in a stationary position to the housing 20. The electromagnetic coil is connected to the power output terminal 60. The power output terminal 60 is connected to the power delivery conductor 14A. In one example, six electromagnetic coils of the generator stator 62 may be mounted at different locations to the housing 20 and two of the electromagnetic coils are connected to the power delivery conductor 14A with two other electromagnetic coils connected to another power delivery conductor (not shown), and the last two electromagnetic coils connected to a further power delivery conductor (not shown). In such an arrangement, three-phase power can be delivered by the six electromagnetic coils of the generator stator 62.

The generator rotor 64 includes a plurality of permanent magnets. The permanent magnets are mounted at various locations around a circumference of the shaft 22. The permanent magnets of the generator rotor 64 are located within electromagnetic fields generated by the various electromagnetic coils of the generator stator 62.

The generator magnetic field line guides 66 are mounted to the housing 20. The generator magnetic field line guides 66 are separate ferromagnetic pieces with gaps between them. A pitch from one of the generator magnetic field line guides 66 to the next is selected to be between one and two millimeters.

Portions of the shaft 22 make up parts of the electric motor 16 and the generator 18. A part of the shaft 22 where the permanent magnets of the motor rotor 54 of the electric motor 16 are mounted serves as a movable output component for the electric motor 16. A part of the shaft 22 where the permanent magnets of the generator rotor 64 of the generator 18 are mounted serves as a movable input component for the generator 18.

The cooling fins 36 are located on an outside of the housing 20. The housing 20 and the cooling fins 36 are typically manufactured from the same block of material in one or more casting and/or machining operations.

In use, a voltage is applied to the power supply conductor 12A. The voltage that is applied to the power supply conductor 12A is one of three phases that are supplied by a voltage-to-frequency converter (VFC). The VFC receives its power as alternating current (AC) from the grid after the power is connected to three-phase sinusoidal power. The VFC then provides three-phase power as a predetermined waveform to manage optimal operation of the electric motor 16.

The motor stator 52 generates a motor coil magnetic field. The motor coil magnetic field is an electromagnetic field that may have its own idiosyncrasies such as creating a coiled shape. The motor magnetic field line guides 56 serve to shape the motor coil magnetic field into a helical shape having a pitch corresponding to the pitch of the motor magnetic field line guides 56.

The stator magnet of the motor rotor 54 is located within the motor coil magnetic field. Interactions between the motor rotor 54 and the motor coil magnetic field causes rotation of the shaft 22. The VFC switches the voltage on the power supply conductor 12A in a select waveform manner to switch of the motor coil magnetic field and cause continuous rotation of the shaft 22 as the permanent magnets of the motor rotor 54 are repelled by and attracted by the motor coil magnetic field. Mechanical power that is created by the shaft 22 is used to rotate the push fan 28, the pull fan 30, and the generator rotor 64.

The stator magnets of the generator rotor 64 create a generator rotor magnetic field that interacts with the generator stator 62 and creates a voltage on the power delivery conductor 14A. The generator magnetic field line guides 66 control the shape of the electromagnetic field that is created by the interaction between the generator rotor 64 and the generator stator 62 such that the electromagnetic field has a coil shape with a pitch of between one and two millimeters.

An advantage of a configuration that has a separate electric motor 16 and generator 18 is that the power that is provided to the power supply conductor 12A is not connected or coupled, at any stage, to the power delivered on the power delivery conductor 14A. Any idiosyncrasies or “dirtiness” of the power that is delivered from the electric grid can thus be isolated to the electric motor 16 without effecting the generator 18 in any electrical or electromagnetic way. The only power connection between the electric motor 16 and the generator 18 is through the shaft 22 that provides a purely mechanical connection for power transfer from the electric motor 16 to the generator 18.

I have found that uncoupling the power of the electric grid from the power that is delivered, that the power that is delivered creates significantly less heat. Such a reduction in heat has allowed me to charge batteries much faster without the batteries generating heat in a manner that is conventional using direct power from the electric grid. When the production of heat is reduced, more power can be provided to such batteries, as will be commonly understood. However, I believe that I have also witnessed charging rates that are in excess of what can be explained with merely the ability to provide more power due to the reduction in heat. It is possible that the nature of the current itself may be different than the nature of the current that is provided by the electric grid. I have speculated that the current is delivered is cleaner and therefore more effective in its application. The interested reader may refer to U.S. Pat. No. 10,615,640, which is incorporated herein by reference in its entirety.

While I have seen significant reductions in heat being generated at the point of delivery, for example at batteries that are being charged, it has not solved my problems with the generation of heat that is created by electric motors and generators. Heat that is generated by the electric motor 16 and generator 18 have limited the amount of power that can be provided to the power supply conductor 12A without causing overheating of the electric motor 16, the generator 18, and the system 10 as a whole. Removal of heat by the push fan 28 and the pull fan 30 have enabled me to provide much larger amounts of electric power to the power supply conductor 12A without causing overheating of the system 10.

The push fan 28 receives ambient air from the left through the opening in the air inlet piece 32 and propels the air to the right through the openings 46 into the housing 20. The air then flows over the electric motor 16 and heat convects from the electric motor 16 to the air. The air then flows over the generator 18 and heat convects from the generator 18 to the air. The air then leaves the housing 20 through the openings 48. The pull fan 30 receives the air from the left and then discharges the air to the right through the opening in the air outlet piece 34 to the ambient. I have found that placing the push fan 28 and the pull fan 30 on opposing sides of the unit, made up of the electric motor 16 and the generator 18, to be significantly more effective than having only one fan. More heat conducts from inside the housing 20 through a wall of the housing 20 to the cooling fins 36 and the heat then convects from the cooling fins 36 to ambient air. These combined cooling techniques have allowed me to drive the system 10 at higher rotational speeds without overheating and to approach the limits of the benefits in power delivery due to being disconnected from the grid power.

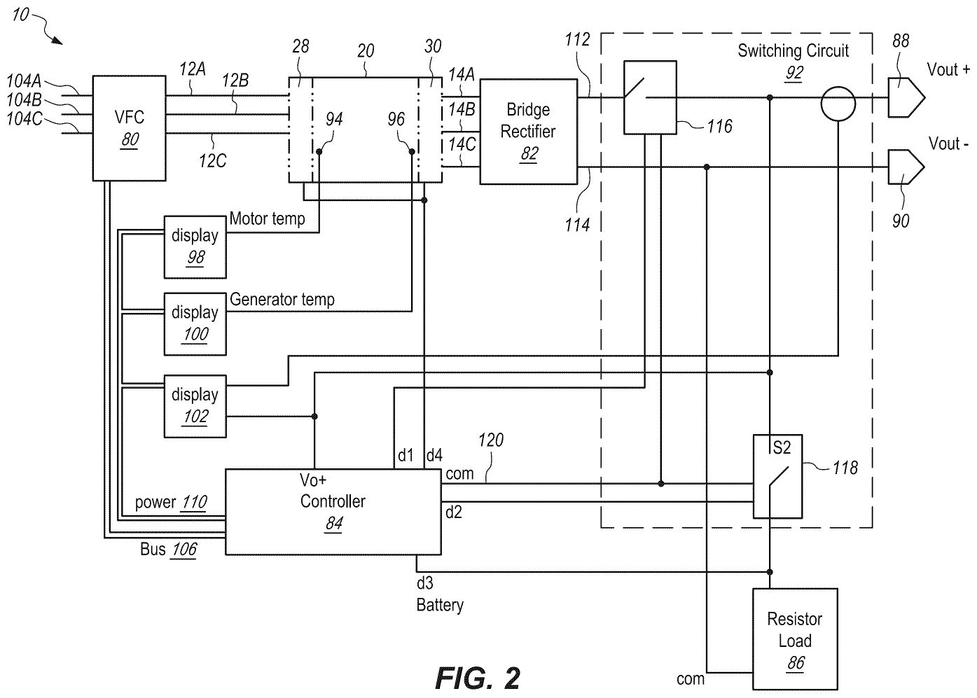

FIG. 2 illustrates further components of the system 10, including a VFC 80, a bridge rectifier 82, a controller 84, a resistor load 86, battery charging terminals 88 and 90, a switching circuit 92, an electric motor temperature sensor 94, a generator temperature sensor 96, and first, second, and third displays 98, 100 and 102, respectively.

The VFC 80 has three power inputs 104A, 104B, and 104C through which three-phase power can be provided to the VFC 80. The VFC 80 is connected to the electric motor 16 (in FIG. 1) located within the housing 20 via three power supply conductors 12A, 12B, and 12C. The VFC 80 is connected to the controller 84 via a BUS 106. The controller 84 controls power provided by the VFC 80 over the power supply conductors 12A, 12B, and 12C in a manner that ensures optimal performance of the electric motor 16. The displays 98, 100 and 102 are connected to the controller 84 through a power line 110 that provides power to the displays 98, 100 and 102. The display 98 is connected to the electric motor temperature sensor 94 and displays the temperature of the electric motor 16 (See FIG. 1). The display 100 is connected to the generator temperature sensor 96 and displays the temperature of the generator 18 (see FIG. 1).

The generator 18 is connected to the bridge rectifier 82 through three power delivery conductors 14A, 14B, 14C that provide three-phase power to the bridge rectifier 82. The bridge rectifier 82 converts the three-phase power to direct current (DC) on positive and negative output lines 112 and 114.

The switching circuit 92 includes first and second switches 116 and 118. The first switch 116 connects the output terminal 112 to the battery charging terminal 88. The output terminal 114 of the bridge rectifier 82 is directly connected to the voltage charging terminal 90. The second switch 118 connects the battery charging terminal 88 to the resistor load 86. The first and second switches 116 and 118 are connected through a communications line 120 to the controller 84 so that the controller 84 can switch the first and second switches 116 and 118. The controller 84 is also connected to the first switch 116, the second switch 118, the resistor load 86, and the electric motor and generator temperature sensors 94 and 96 through communication connections d1, d2, d3, and d4 respectively. The controller 84 can thus monitor the status of the first and second switches 116 and 118, a voltage of the battery, and temperatures of the electric motor 16 and generator 18. The display 102 is connected to the battery charging terminal 88 and displays a voltage of the battery.

In use, the controller 84 first sets the switching circuit 92 to standby mode. In standby mode the first and second switches 116 and 118 are open. The power output terminals 114A, 114B, and 114C as well as the terminal 112 are disconnected from the battery charging terminal 88 and therefore disconnected from the battery. The battery charging terminal 88, and therefore the battery, is also disconnected by the second switch 118 from the resistor load 86.

The controller 84 then switches the switching circuit 92 to a charging configuration, wherein the first switch 116 is closed and the second switch 118 is open. The battery is then connected to the terminal 112 and through the bridge rectifier 82 to the power delivery conductors 14A, 14B, and 14C. The system 10 then charges the battery. The battery is disconnected using the second switch 118 from the resistor load 86.

The controller 84 then switches the switching circuit 92 to a discharging configuration wherein the first switch 116 is open and the second switch 118 is closed. The controller 84 ensures that the first switch 116 is opened before the second switch 118 is closed; the first switch 116 and the second switch 118 are never closed at the same time. In the battery discharging configuration, the battery is discharged through the battery charging terminal 88 and the second switch 118 to the resistor load 86.

The system 10 has the advantage of being able to discharge a battery extremely quickly. In one example, a lead acid battery system of a forklift vehicle can be discharged within one to two minutes using the resistor load 86. The system 10 may provide 10 KWatt, and operate at 3000 rpm, to the lead acid battery of the forklift vehicle and recharge the battery within one hour. Discharging the battery allows for testing the battery and the battery can be tested and recharged within the lunch hour of an operator. The resistor load 86 is typically a 0.16 Ohm resistor capable of handling 50 volts and 300 amperes. In another configuration, a 21 KWatt forklift charger operating at 7000 rpm can be used with the same resistor load 86 having 0.16 Ohm and capable of 50 volts and 300 amperes.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

1. A system for transferring electric power comprising:
a housing,
a shaft movably mounted to the housing,
a power supply conductor to conduct a power supply current that generates a power supply magnetic field;
an electric motor having a power input terminal connected to the power supply conductor and a movable output component, the electric motor being configured to convert the power supply current to movement of the movable output component; and
a generator having a movable input component connected to the movable output component such that the movable output component causes movement of the movable input component, and a power output terminal, the generator being configured to convert the movement of the movable input component into a power output current to the power output terminal that generates a generator magnetic field that is uncoupled from the power supply magnetic field, wherein the movable output component and the movable input component are parts of the shaft, wherein the motor includes a motor stator mounted to the housing and a motor rotor mounted to the shaft, and wherein the generator includes a generator stator mounted to the housing and a generator rotor mounted to the shaft.

2. The system of claim 1, wherein the motor stator includes at least one motor coil that generates a motor coil magnetic field; and
wherein the motor rotor includes at least one motor permanent magnet that is located in the motor coil magnetic field.

3. The system of claim 2, wherein the generator rotor includes at least one generator permanent magnet that has a generator permanent magnet magnetic field; and
wherein the generator stator includes at least one generator coil that is located in the generator permanent magnet magnetic field.

4. The system of claim 1, wherein the shaft is rotatably mounted to the housing,

5. The system of claim 4, further comprising:
first and second shaft bearings rotatably mounting the shaft to the housing with the electric motor and the generator between the first and second shaft bearings.

6. The system of claim 1, further comprising:
a push fan; and
a pull fan, the push fan and the pull fan being mounted in positions so that air flows sequentially over the push fan, then over a unit that includes the electric motor and the generator, and then over the pull fan.

7. The system of claim 1, further comprising:
a resistor load;
a controller; and
a switching circuit that is connected to the controller, the controller being operable to switch the switching circuit between a charging configuration wherein the power output terminal is connectable to a battery to charge the battery and the battery is disconnected from the resistor load, and a discharging configuration wherein the output terminal is disconnected from the battery and the battery is connected to the resistor load to discharge the battery.

8. A method of transferring electric power comprising:
conducting a power supply current that generates a power supply magnetic field;
converting the power supply current to movement of the movable output component; and
converting the movement into a second electric current that generates a generator magnetic field that is uncoupled from the power supply magnetic field, wherein the movable output component and the movable input component are parts of a shaft, wherein the motor includes a motor stator mounted to the housing and a motor rotor mounted to the shaft, and wherein the generator includes a generator stator mounted to the housing and a generator rotor mounted to the shaft.

9. The method of claim 8, wherein the motor stator includes at least one motor coil that generates a motor coil magnetic field; and
wherein the motor rotor includes at least one motor permanent magnet that is located in the motor coil magnetic field.

10. The method of claim 9, wherein the generator rotor includes at least one generator permanent magnet that has a generator permanent magnet magnetic field; and
wherein the generator stator includes at least one generator coil that is located in the generator permanent magnet magnetic field.

11. The method of claim 8, wherein the shaft is rotatably mounted to the housing.

12. The method of claim 11, wherein first and second shaft bearings rotatably mount the shaft to the housing with the electric motor and the generator between the first and second shaft bearings.

13. The method of claim 8, wherein air is directed over a push fan and a pull fan so that air flows sequentially over the push fan, then over a unit that includes the electric motor and the generator, and then over the pull fan.

14. The method of claim 8, further comprising:
switching, with a controller, a switching circuit between a charging configuration wherein the output terminal is connectable to a battery to charge the battery and the battery is disconnected from a resistor load, and a discharging configuration wherein the output terminal is disconnected from the battery and the battery is connected to the resistor load to discharge the battery.

15. A system for transferring electric power comprising:
means for conducting a power supply current that generates a power supply magnetic field;
means for converting the power supply current to movement of the movable output component; and
means for converting the movement into a second electric current that generates a generator magnetic field that is uncoupled from the power supply magnetic field,
wherein the movable output component and the movable input component are parts of a shaft,
wherein the motor includes a motor stator mounted to the housing and a motor rotor mounted to the shaft, and
wherein the generator includes a generator stator mounted to the housing and a generator rotor mounted to the shaft.

16. The system of claim 15, wherein the motor stator includes at least one motor coil that generates a motor coil magnetic field; and
wherein the motor rotor includes at least one motor permanent magnet that is located in the motor coil magnetic field.

17. The system of claim 16, wherein the generator rotor includes at least one generator permanent magnet that has a generator permanent magnet magnetic field; and
wherein the generator stator includes at least one generator coil that is located in the generator permanent magnet magnetic field.

18. The system of claim 15, wherein the shaft is rotatably mounted to the housing.

19. The system of claim 18, wherein first and second shaft bearings rotatably mount the shaft to the housing with the electric motor and the generator between the first and second shaft bearings.

20. The system of claim 15, wherein air is directed over a push fan and a pull fan so that air flows sequentially over the push fan, then over a unit that includes the electric motor and the generator, and then over the pull fan.

21. The system of claim 15, further comprising:
means for switching a switching circuit between a charging configuration wherein the output terminal is connectable to a battery to charge the battery and the battery is disconnected from a resistor load, and a discharging configuration wherein the output terminal is disconnected from the battery and the battery is connected to the resistor load to discharge the battery.

22-72. (canceled)
